(19) United States
(12) Patent Application Publication
(10) Pub. No.: US 2010/0013228 A1
(43) Pub. Date: Jan. 21, 2010

(54) SURFACE PIERCING TIDAL GENERATOR

(76) Inventors: Tony Duggleby, San Francisco, CA (US); Nancy Levidow, San Francisco, CA (US); Paul Kamen, Berkeley, CA (US)

Correspondence Address: DERGOSITS & NOAH LLP, Three Embarcadero Center, Suite 410, SAN FRANCISCO, CA, 94111, US

(21) Appl. No.: 12/432,530

(22) Filed: Apr. 29, 2009

Related U.S. Application Data
(60) Provisional application No. 61/048,903, filed on Apr. 29, 2008.

(51) Int. Cl. F03B 13/26

(52) U.S. Cl. 290/53

(57) ABSTRACT

A tidal generator includes a floating structure and a shaft that is supported over a moving body of water. The shaft is coupled to multiple rotors that have pitched blades that extend radially from the center of the rotor. Portions of the lower blades are submerged in the moving water. The movement of the water relative to the tidal generator causes the rotors and shaft to rotate. The shaft is coupled to an electrical generator.

### CROSS REFERENCE TO RELATED APPLICATIONS

This application claims priority to U.S. Provisional Patent Application No. 61/048,903, SURFACE PIERCING TIDAL GENERATOR, filed Apr. 29, 2008, which is hereby incorporated by reference.

### BACKGROUND

Tidal generators convert the energy of tides or other forms of moving water into electricity or other useful forms of power. There are several types of existing tidal generators. For example, tidal stream systems make use of the kinetic energy of moving water to power turbines, in a similar way to windmills that use moving air. Barrage systems make use of the potential energy in the difference in height between high and low tides. Barrages are essentially dams across the full width of a tidal estuary. Tidal lagoon systems, are similar to barrages, but can be constructed as self contained structures that do not extend fully across an estuary.

Tidal stream turbines may be arrayed in high-velocity areas where natural tidal current flows are concentrated. Such flows occur almost anywhere where there are entrances to bays and rivers, or between land masses where water currents are concentrated. Tidal stream generators draw energy from currents in much the same way as wind turbines. The higher density of water, 832 times the density of air, means that a single generator can provide significant power at tidal flow velocities that are significantly lower than the necessary wind speed for a wind generator. Given that power varies with the density of medium and the cube of velocity, it is easy to see that water speeds of nearly one-tenth of the speed of wind provides the same power for the same size of turbine system. However, this limits the application in practice to places where the tide moves at speeds of at least 2 knots (1 m/s).

A problem with most tidal generators is that they are expensive to install and difficult to maintain. In general, the existing tidal generators are mounted on the sea floor so that all required generator components are underwater. This makes it very difficult and expensive to repair the tidal generators. For example, Verdant Power has been running a tidal-power project in the East River in New York City since 2007. The strong currents in the river caused the blades of the generator to break off multiple times. In order to fix the generator, the entire unit was removed from the bottom of the river which required a special barge and crane. Another problem with submerged tidal generators is the turbine blades will accumulate marine growth over time. The exposed surfaces of the blades are painted with a toxic anti-fouling paint or other anti-fouling surface treatment. These treatments will need to be reapplied at least every few years which requires removing the blades or the entire tidal generator. What is needed is a simplified tidal generator that is easily installed and maintained.

### SUMMARY OF THE INVENTION

The present invention is directed towards a floating tidal generator that includes a floating structure and a plurality of rotors that are mounted on a shaft. The floating structure is secured to a stationary surface which can be a mooring or a portion of land so that the tidal water flows under the floating structure. The rotors have pitched blades that have a high aspect ratio and extend radially outward from the centers of the rotors. The aspect ratio defines the relationship between the blade span “b” and the blade area “S” by the equation aspect ratio b^{2/}S. In an embodiment, the aspect ratio of the blades is equal to or greater than 2.0. The shaft and most of the rotors are suspended above the water with only a lower portion of the rotor blades submerged. The movement of the water causes the rotor blades to rotate about the shaft. Thus, each of the blades pierces the water, travels through the water and then emerges from the water during each rotation of the rotor. The shaft can be coupled to an electrical generator that transmits electrical power through an underwater or floating cable to shore. One of the main advantages of surface piercing rotor blades is that since the blades are above the water line, they are easily cleaned of marine growth without having to remove the blades from the tidal generator. This eliminates or greatly reduces the need for toxic anti-fouling paints or other anti-fouling surface treatments as well as complex and costly maintenance required to regularly clean and paint the turbine blades of a fully submerged tidal generator.

In an embodiment, the flow of the water under the tidal generator can be aligned with the shaft. When the shaft is aligned with the flow of the water, the water will contact the first rotor and subsequently, the water will flow through all downstream rotors. As the water flows across the rotor blades, there is a reduction in the water velocity resulting from the extraction of kinetic energy from the upstream rotor as well as some turbulence is produced. This reduction in water velocity will reduce the power that can be applied to the blades of the subsequent rotors. At the last rotor, the water velocity will be slower and the turbulence will be higher.

In this embodiment, the front of the tidal generator can be coupled to a mooring and the tidal generator can align itself with the water flow. If the current direction changes, the tidal generator will rotate around the mooring to correct the alignment. Alternatively, the front and rear of the tidal generator can both be coupled to mooring lines to hold the generator in a more restricted or fixed orientation in the water.

In an embodiment, the tidal generator can be supported by pontoons that provide buoyancy. Cross beams are mounted between the pontoons and the spaces between the slots provide open spaces. One or more shafts can extend along the length of the tidal generator across the open spaces. The shafts can be supported by bearings mounted on the cross beams. A plurality of rotors can be mounted at uniform intervals along the length of the shaft so the rotors are positioned within the open slots. The blades on the lower portion of the rotors contact the water under the tidal generator and the movement of the water over the rotor blades causes the rotors to rotate.

In another embodiment, the tidal generator can include a central barge that provides buoyancy and rotors that are mounted on opposite sides of the barge. In this embodiment, each rotor can rotate on its own shaft. The pitch of the rotor blades on opposite sides of the barge can be opposite. This will cause the rotors on either side of the barge to rotate in opposite directions. The resistance caused by the rotors will apply a side force to the barge. However, since the rotors rotate in opposite directions, the side forces will substantially cancel each other out and the barge will tend to be properly aligned in the water. Additional rotors downstream also include rotor blades that are pitched in an opposite direction to the up stream rotor and the rotor on the opposite side of the tidal generator. The downstream rotor blades have an opposite rotation relative to the upstream rotor in order to recover rotational energy left in the water flow by the upstream rotor.

In yet another embodiment, the rotors can be coupled to a wide diameter tube that provides buoyancy to partially support the tidal generator. Rather that having individual rotors coupled to the shaft, the rotors blades are coupled directly to the outer diameter of the tube. In this embodiment, the stationary structures are located at the ends of the tube and keels can extend from the bottoms of the stationary structures. The flow of water over the keels provides stability to keep the ends of the structure stable and the keels can be weighted to provide additional stability. The stationary structures can be coupled by an elongated member that extends through the center of the tube.

In order to minimize the reduction in water velocity and reduce the turbulence of the water flowing to the downstream rotors, the shaft can be angled relative to the flow of the water. By angling the shaft, the rotors on the shaft are offset and much of the loss in velocity and turbulence produced by the leading rotors will not flow directly into the subsequent downstream rotors. In order to hold the tidal generator at an angle to the water flow, the front and back ends of the tidal generator can be coupled to one or more moorings.

There are numerous variables that are associated with the rotors. For example, the number of blades on each rotor can vary from 6 or less to 16 or more. The length of the blades is also variable. The cross section of the blades can be a hydrodynamic foil shape that has a high lift to drag ratio. In order to simply the design of the tidal generator, the pitch angle of the rotor blades may be fixed. The preferred pitch of the rotor blade will depend upon the velocity of the water. In areas where the water velocity is fairly constant such as a river, the rotor blades can be set to the expected water velocity.

Normally, the pitch of the rotor blades is fixed and the rotational speed of the rotors changes in proportion to variation in the current speed. Thus, the angle of attack of the blades remains constant over a very wide range of current speeds without any change in the rotor blade geometry. However, in applications where there are substantial variations in the water velocity, the rotor blade pitch can be variable with the blades set to a high pitch angle in low velocity water and a lower pitch angle in higher velocity conditions. In this embodiment, a water flow sensor can be coupled to the housing and the system can mechanically alter the pitch of the rotors blades based upon the detected water velocity.

Even if the pitch angle if fixed, it is possible to alter the attack angle of the blades to the water by moving the angle to the rotors to the water flow direction. The normal pitch can be set for water flowing directly under the shaft. By changing the angle of the shaft, the attack angle of the blades is altered. In an embodiment, the tidal generator can be configured to alter the pitch to keep the rotational velocity of the shaft within a predetermined range. Thus, at low water velocity, the shaft angle is moved to increase the attack angle of the blades and as the water velocity increases, the shaft is moved to decrease the angle of attack. By decreasing the angle of attack, the lift forces on the blades are decreased which can prevent damage to the tidal generator.

The inventive tidal generator has numerous advantages over the prior art tidal generator systems. The design is simplified because the drive shaft, bearing and generator are above the water line and only the lower rotors blades and the floating structure are submerged. Since the main generator components are above water, there are no complicated seals or underwater mechanisms that can leak and cause a system failure. The tidal generator is also more easily moved to the installation site. The tidal generator is towed to an installation site and secured to a fixed object such as a mooring coupled to the sea floor or a portion of land. Thus, there is no need to mount the entire tidal generator underwater which requires specialized installation equipment including cranes and divers working in a high water velocity area. When maintenance is required, the inventive tidal generator can be towed to a dock for repairs. In contrast, when a submerged tidal generator needs to be repaired, it may need to be removed from the sea floor which can be very difficult. In summary, the inventive tidal generator is simpler and safer system that will made tidal power more accessible.

### BRIEF DESCRIPTION OF THE DRAWINGS

FIG. 1 is an upper perspective view of an embodiment of a surface piercing tidal generator;

FIG. 2 is a lower perspective view of an embodiment of a surface piercing tidal generator;

FIG. 3 is an upper perspective view of an embodiment of a surface piercing tidal generator;

FIG. 4 is a view of a rotor;

FIG. 5 is a side view of an embodiment of a surface piercing tidal generator;

FIG. 6 is a front view of an embodiment of a surface piercing tidal generator;

FIG. 7 is a top view of an embodiment of a surface piercing tidal generator;

FIG. 8 is a top view of an embodiment of a surface piercing tidal generator;

FIG. 9 is a side view of an embodiment of a surface piercing tidal generator;

FIG. 10 is a view of a rotor;

FIG. 11 is a view of a rotor blade;

FIG. 12 is a view of a rotor blade;

FIG. 13 is a bottom view of a rotor;

FIG. 14 is a bottom view of an angled rotor;

FIG. 15 is a bottom view of an angled rotor;

FIG. 16 is a top view of an embodiment of a surface piercing tidal generator; and

FIG. 17 is a side view of an embodiment of a surface piercing tidal generator.

### DETAILED DESCRIPTION

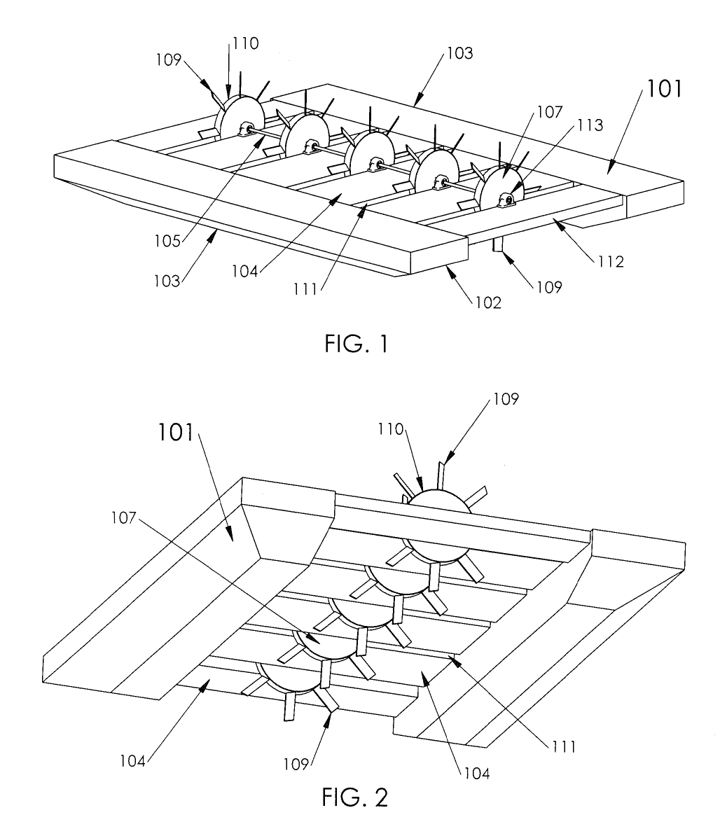

With reference to FIGS. 1 and 2, an embodiment of the surface piercing tidal generator 101 is illustrated. The surface piercing tidal generator 101 consists of a floating housing 105, a shaft 105 and a plurality of rotors 107 mounted on the shaft 105. In this embodiment, the floating housing 105 includes two pontoons 103 that provide buoyancy and cross beams 104 that extend between the pontoons 103 above the water. The spaces between the cross beams 104 provide open slots 111.

The shaft 105 is coupled to bearings 113 mounted on top of the cross beams 104 between the pontoons 103. The shaft 105 is parallel to the pontoons 103 and rotors 107 are mounted on the shaft 105 in the open slots 111. In this embodiment, each of the rotors 107 includes a center ring 109 and a plurality of pitched high aspect ratio blades 109 that extend radially from the ring 109. The blades 109 are the only portion of the rotor 107 used to catch the water moving under the floating housing 105. The ring 109 portion of the rotor 107 does not enter the water and only provides structural support for the rotor 107 and blades 109.

The aspect ratio “AR” of the blade 109 defines a relationship between the blade span “b” and the blade area “S.” The area of the blade 109 is defined by the equation: S=b×standard mean cord “SMC” of the blade 109. The aspect ratio is defined by the equation: AR=b²/S. In a preferred embodiment, the aspect ratio of the blades 109 is equal to or greater than 2.0.

The floating housing 105 is placed in a moving body of water and a front end 115 of the housing 105 is secured to a fixed object which can be the sea floor or a mooring line. As the water moves under the housing 105, the flow of the water moves against the blades 109 of the rotors 107 causing them to rotate about the shaft 105. The movement of the water will also cause the pontoons 103 to become aligned with the flow of the water. In an embodiment, the tidal generator 101 is bi-directional and will function equally well with water flowing in either direction in line with the shaft 105.

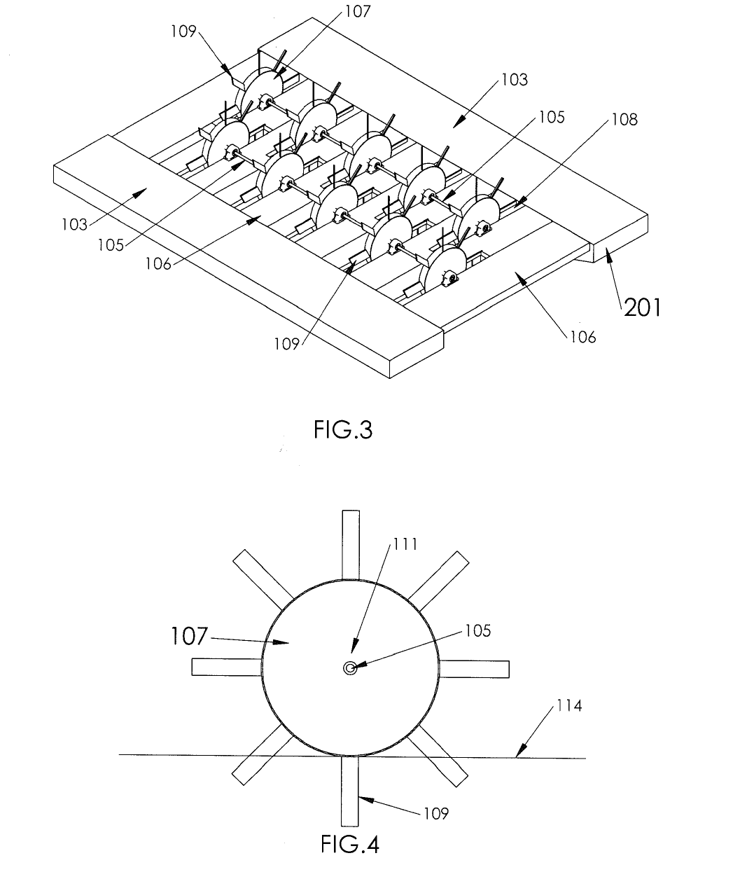

With reference to FIG. 3, another embodiment of the tidal generator 201 is illustrated. In this embodiment, the tidal generator includes two pontoons 103 and two shafts 105 mounted between the pontoons 103. The rotors 107 are mounted at equal distances along the length of the shafts 105. However, the rotors 107 on one shaft 105 are offset from the rotors 107 on the other shaft 105. In this embodiment, a center cross beam 106 has slots 108 that provide clearance for the blades 109 and allow the rotors 107 to rotate.

With reference to FIG. 4, a detailed illustration of the rotor 107 is shown. The shaft 105 is coupled to a central hub 111 and the blades 109 extend from the central hub 111. The hub 111 is suspended above the water line 114 and the blade 109 is positioned directly under the hub 111 and almost fully submerged. Water is about 800 times the density of air, so the hydraulic forces on the blades 109 is substantially larger than the pneumatic forces on the blades 109 above the water line.

One of the main advantages of a surface piercing blade design is that the blades can be easily cleaned to remove marine growth or biofouling which includes microorganisms, plants, algae and animals on wetted structures. Biofouling will significantly reduce the performance of the rotor blades and reduce the power output of the tidal generator. In order to reduce biofouling, many underwater structures are protected by antifouling coatings. Many types of these coatings such as anti-fouling paint are toxic to marine organisms. The tidal generator is equipped with a mechanism to stop the rotation of the rotors. While stopped, the rotors blades above the water line can be easily cleaned by wiping down the surfaces and/or pressure washing with water. This simplified cleaning process eliminates or greatly reduces the need for toxic anti-fouling paints or other anti-fouling surface treatments. This also eliminates the complex and costly maintenance required to regularly clean and paint the turbine blades of a fully submerged tidal generator.

With reference to FIGS. 5-7, another embodiment of the tidal generator 301 is illustrated. The tidal generator 301 includes a central barge 303 that provides buoyancy and rotors 107 that are mounted on opposite sides of the barge 303. In this embodiment, there are four rotor 107 that each rotate on a separate shaft. In other embodiments, additional rotors 107 can be coupled to the barge 303. Support braces 121 are coupled to the barge 303 and provide support to the shafts that are coupled to the rotors 107. The front and rear ends of the barge 303 have sloped surfaces which improve the water flow under the barge 303. The barge 303 should be aligned with the water flow direction. Because tidal currents will flow in one direction and then the opposite direction, the tidal generator 301 will function with water flowing in either direction under the barge 303.

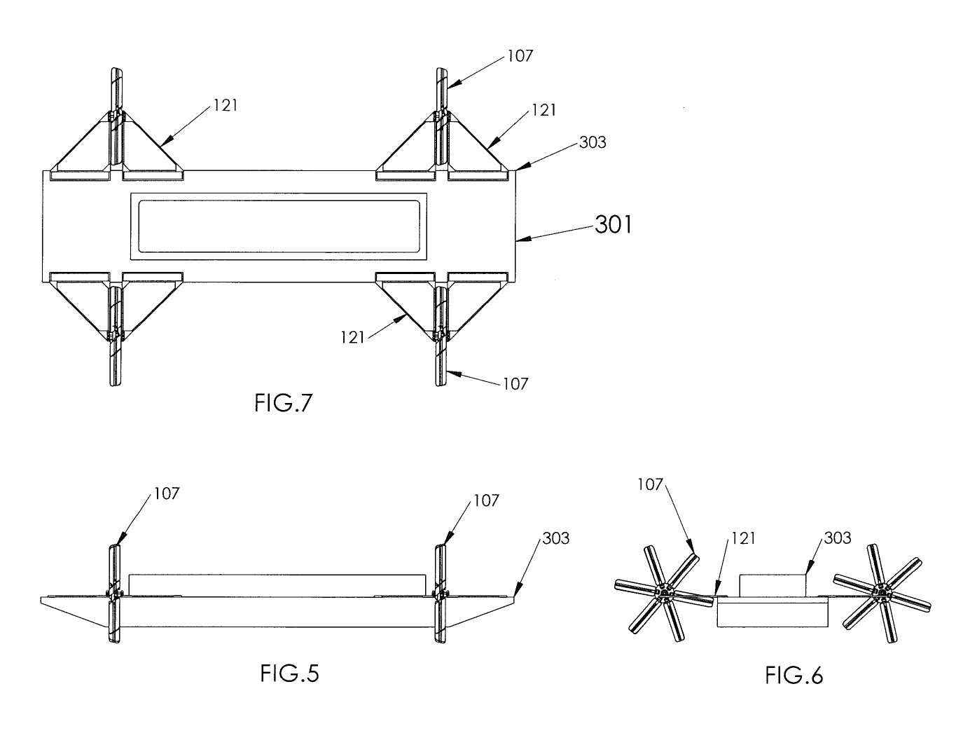

The pitch of the rotor blades 107 on opposite sides of the barge are opposite which causes the rotors on either side of the barge to rotate in opposite directions. The resistance caused by the rotational force applied to the rotors 107 will apply a side force to the barge. However, since the rotors 109 rotate in opposite directions, the side forces will substantially cancel each other out and the tidal generator 301 will tend to be properly aligned in the water. The downstream rotors 107 are pitched in an opposite direction to the upstream rotor 107 and the rotor 107 on the opposite side of the barge 303. Because the downstream rotor blades 107 have an opposite rotation to the upstream rotor in order to recover rotational energy left in the water flow by the upstream rotor 107. With reference to FIG. 6, if the water flows towards the front of the barge, the left front rotor 107 will rotate clockwise, the right front rotor 107 will rotate counter clockwise, the left rear rotor 107 will rotate counter clockwise and the right rear rotor 107 will rotate clockwise.

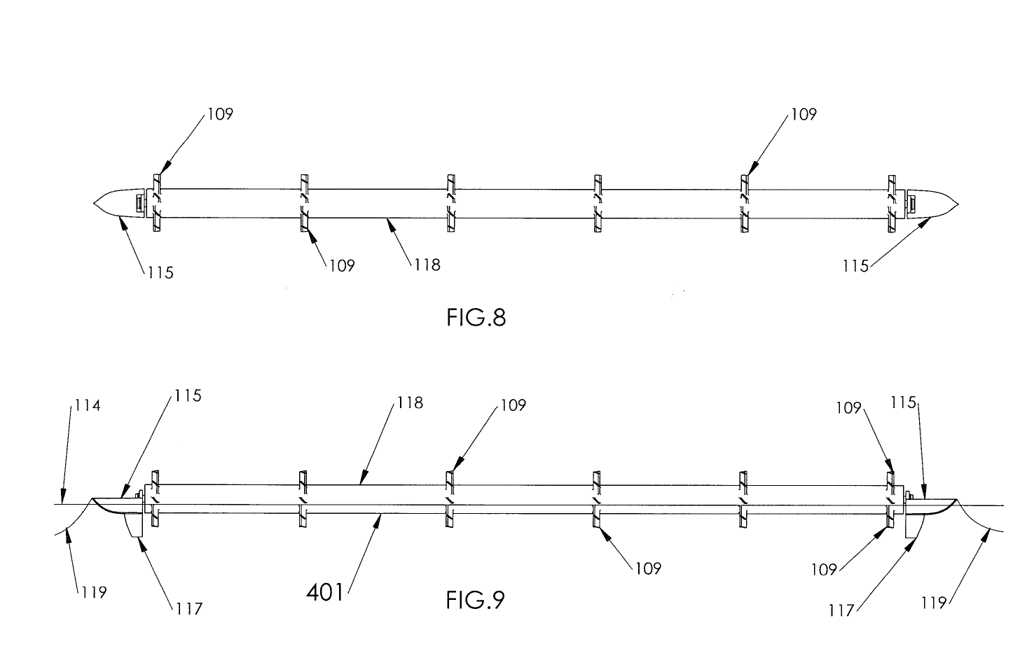

In FIGS. 8 and 9, another embodiment of the tidal generator 401 is illustrated. In this embodiment, the floating housings 115 are at the ends of the tidal generator and the blades 109 extend from a tubular structure 115. The tubular structure 115 is partially submerged and provides buoyancy and structural support for the tidal generator 401. This tubular structure 115 has a wide diameter that prevents bending. The tubular structure 115 rotates relative to the floating housing 115. In order to prevent the floating housings 115 from rotating, thin fin keels 117 are mounted to the bottoms of the floating housings 115. The flow of water around the keels 117 helps to stabilize the floating housings 115. In an embodiment, the keel 117 can include a high density weight to keep the floating housings 115 upright. The floating housings 115 are coupled to mooring lines 119 that hold the tidal generator 201 in place. The underwater shape of the floating housings 115 can have a semi circular shape that matches the diameter of the tubular structure 115 and have a tapered hydrodynamic shape to reduce the drag forces due to water flow.

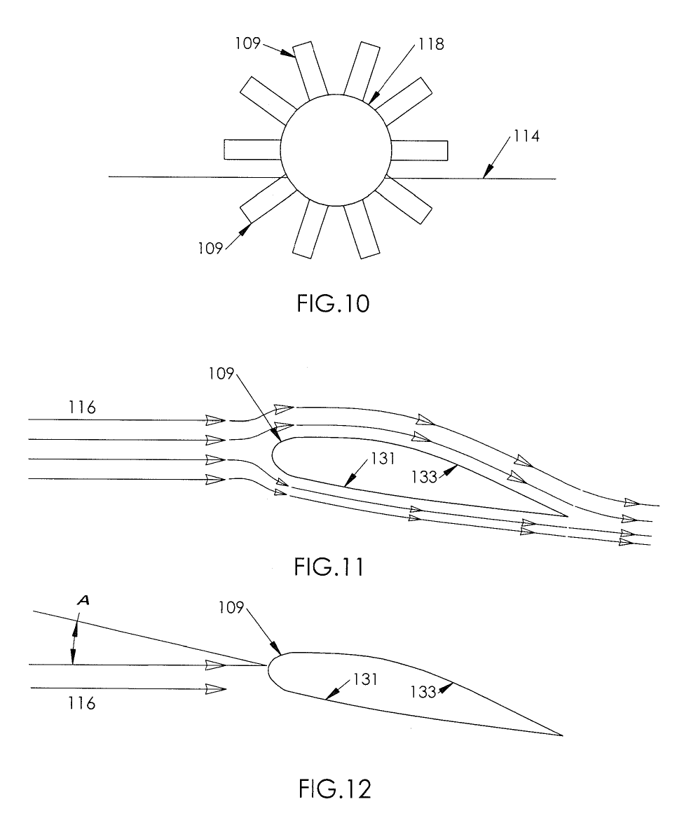

With reference to FIG. 10 a cross section of the tubular structure 115 and the rotor blades 109 are illustrated. The rotor blades 109 at the bottom of the tubular structure 115 are completely submerged below the surface of the water 114. The tubular structure 115 is hollow and can be sealed at the ends. Thus, the submerged portion of the tubular structure 115 provides buoyancy which helps to support the tidal generator 401.

With reference to FIGS. 11 and 12, a rotor blade 109 is illustrated having a characteristic shape of a rounded leading edge, followed by a sharp trailing edge, often with asymmetric camber. As the water 116 flows around the blade 109, a higher pressure is applied to the lower surface 131 than the upper surface 133 which results in a lift force on the rotor blade 109. The angle of attack α is the angular difference between the water flow 116 and the rotor blade 109. A higher angle to attack α can produce higher lift and drag forces and a lower angle of attack α can result in lower lift and drag forces. The illustrated rotor blade 109 will be more efficient when used with a unidirectional water flow. However, if the tidal generator is used in an application that provides water flow in two directions, a more symmetrical rotor blade 109 should be used.

In general, the angle of attack of the rotor blades 109 will be fixed and the rotational velocity of the rotor will be proportional to the water current speed. However, in other embodiments, it is possible to have a variable pitch system that alters the pitch of the rotor blades 109 to maintain the rotational velocity of the rotors within a predetermined range. The rotor blades 109 can be set to a high pitch angle in low velocity water and a lower pitch angle in higher velocity conditions. In this embodiment, a water flow sensor can be coupled to the housing and the system can mechanically alter the pitch of the rotors blades based upon the detected water velocity.

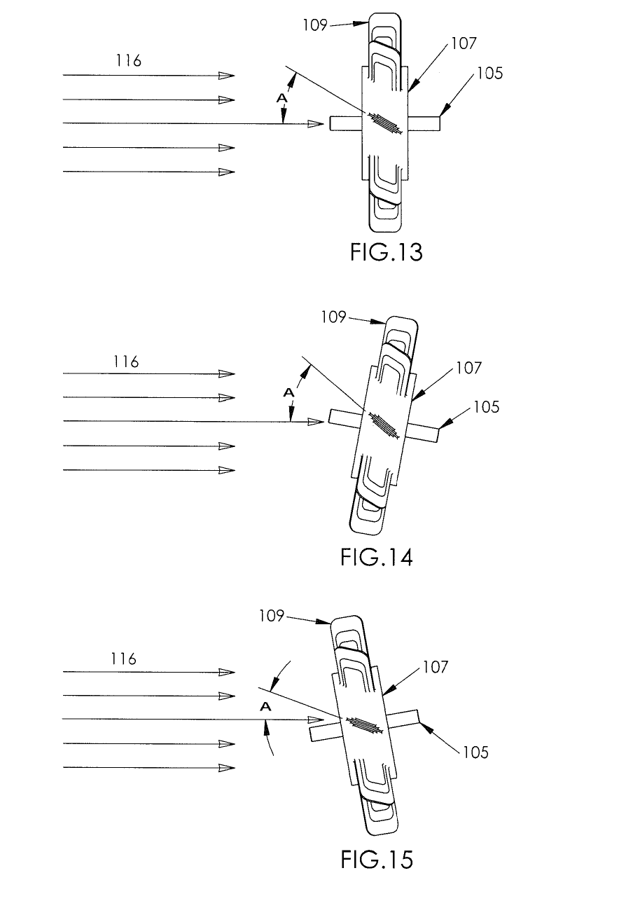

With reference to FIGS. 13-15 a bottom view of a rotor 107 is illustrated. In FIG. 13, the shaft 105 is aligned with the water flow 116 and the rotor blades 109 have an angle of attack α relative to the water flow 116. If the shaft 105 is rotated out of alignment with the water flow 116, the angle of attack α will change. With reference to FIG. 14, the shaft 105 is rotated resulting in a lower angle of attack α and with reference to FIG. 15, the shaft 105 is rotated in an opposite direction to increase the angle of attack α. Thus, by changing the angle of the rotors 107 relative to the water flow direction, the angle of blades 109 can be controlled. Another benefit of angling the shaft relative to the direction of the water is that the upstream rotor blades 109 have less influence on the downstream rotor blades 109. When the water contacts the upstream rotor blades 109, the water velocity is reduced by the kinetic energy that is extracted by the upstream rotor blades 109 and some turbulence is also generated. This reduced water velocity and turbulence flows directly downstream and will reduce the power output of downstream rotor blades 109. By angling the rotor blades 109 out of alignment, the reduced water velocity and turbulence produced by the rotor blades 109 will not flow directly into the downstream rotor blades 109. Because the downstream rotor blades 109 are exposed to faster velocity water that is turbulent water, the efficiency of the tidal generator is improved.

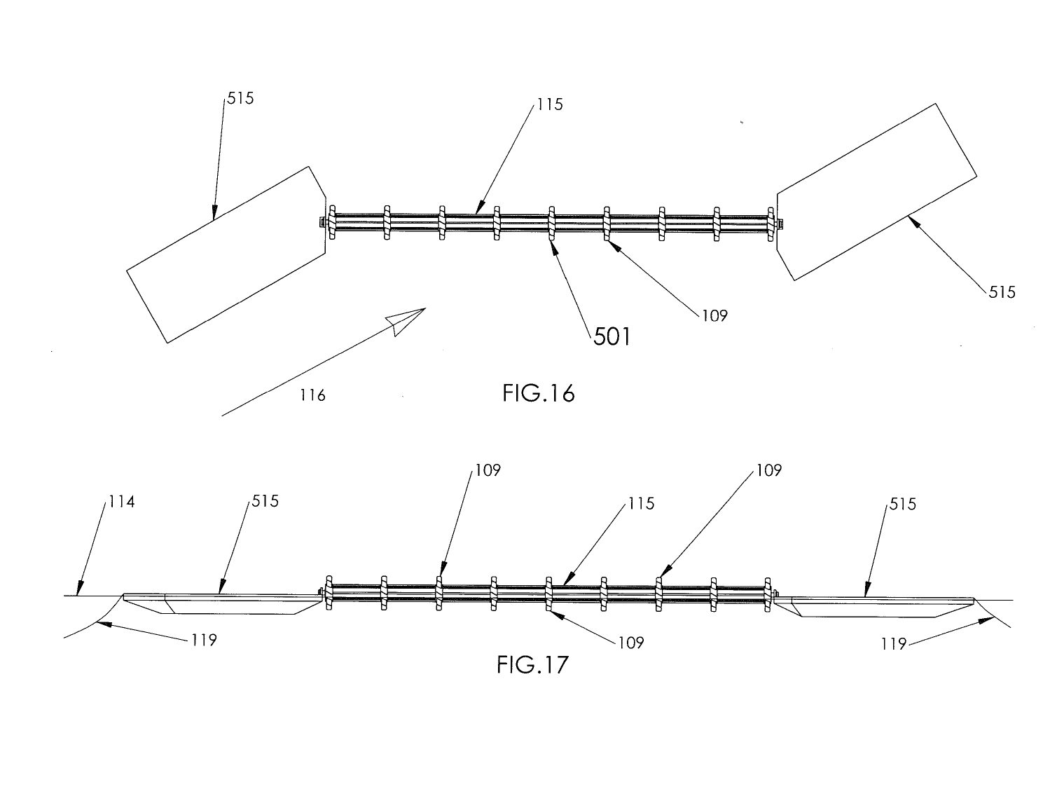

With reference to FIGS. 16 and 17, an angled tidal generator 501 is illustrated. An elongated tube 115 is mounted between two floating support structures 515. The floating structures 515 are held in place by mooring lines 119. In this example, the tube 115 is angled at about 30° relative to the water flow direction 116. The rotor blades 109 are angled at about 45° relative to the tube 115.

It is possible to calculate a theoretical power output for a tidal generator based upon the water speed and known information about the tidal generator. For example, the water flow is 13.5 ft/sec and the shaft is rotated in yaw by 30° and the turbulent water flow interference is reduced. Use tangential speed=13.5 feet/sec, same as flow velocity. Vector diagram becomes isosceles triangle, so relative water speed across blade=13.5 ft/sec. Since the rotor blades 109 are angled at 45° to the tube 115, the angle of attack of the blades 109 against the water 116 is about 15°. The angle of pressure force F on blade to tangential motion of blade=45°.

F=½(rho)Cd A V²

where:

rho=water density=1.9905 slugs/ft³

Cd=drag coefficient, assume 1.0 (conservative)

A=blade area

Applying these numbers to calculate the blade pressure F and tangential component per square feet of blade area F-tangential:

$$F = 1 / 2 \; 1.9905 {13.5}^{2} = 181.38 lb \text{/} {ft}^{2}$$

$$F \text{-} tangential = 181.38 \times COS 45 ° = 128.26 lb \text{/} {ft}^{2}$$

$$\begin{matrix}Power = F V \text{-} paddle \\ = 128.26 \times 13.5 \\ = 173 ft \text{-} lb \text{/} sec \text{/} {ft}^{2} \\ = 3.15 HP \text{/} {ft}^{2} \\ = 2.35 K W \text{/} {ft}^{2} \\ = 25.3 K W \text{/} {m}^{2}\end{matrix}$$

The active blade area is calculated based upon a tidal generator having 9 rotors, 8 blades per rotor and 2 blades immersed in the water per rotor. If the rotor blades have a 3.4 m span and a 2.1 m chord in the developed view, the immersed area per active blade is 7.1 m² and the total active blade area=9×2×7.1=128m². Thus, the theoretical power output=25.3 K W/m²×128 m²=3.2 mw. This theoretical calculation does not include blade and rotor interference effects, frictional drag on blades, power transmission and other losses.

In another example, the water flow velocity and tangential speed=13.5 feet/sec and the relative flow angle is 45 degrees to shaft axis. Thus, the relative flow velocity=13.5/SIN 45°=19.0 ft/sec. The incline of the rotor blades is 15° relative to the water flow direction. Blade lift force will be inclined 60° to tangential direction.

F=½rho Cd A V²

where:

rho=water density=1.9905 slugs/ft³

Cd=drag coefficient, assume 1.0 (conservative)

A=blade area

Blade pressure F and tangential component per blade area F-tangential:

$$F = 1 / 2 \; 1.9905 {19.0}^{2} = 359 lb \text{/} {ft}^{2}$$

$$F \text{-} tangential = 359 \times COS 60 ° = 180 lb \text{/} {ft}^{2}$$

$$\begin{matrix}Power = F V \text{-} paddle \\ = 180 \times 13.5 \\ = 2430 ft \text{-} lb \text{/} sec \text{/} {ft}^{2} \\ = 4.42 HP \text{/} {ft}^{2} \\ = 3.29 K W \text{/} {ft}^{2} \\ = 35.5 K W \text{/} {m}^{2}\end{matrix}$$

Active blade area is calculated based upon the tidal generator having 9 rotors, 16 blades per rotor and 6 immersed blades per rotor. If the rotor blades have a 2.8 m span, 1.1 m chord in developed view, the immersed area per active blade is 3.1 m² and the total active blade area=9×6×3.1=167 m². Thus, the theoretical power output=35.5×167=5.9 mw. Again, this theoretical calculation does not include blade and rotor interference effects, frictional drag on blades, power transmission and other losses.

The foregoing discussion of the invention has been presented for purposes of illustration and description. The foregoing is not intended to limit the invention to the form or forms disclosed herein. In the foregoing description for example, various features of the invention have been identified. It should be appreciated that these features may be combined together into a single embodiment or in various other combinations as appropriate for the intended end use. The dimensions of the component pieces may also vary, yet still be within the scope of the invention. This method of disclosure is not to be interpreted as reflecting an intention that the claimed invention requires more features than are expressly recited in each claim. Moreover, though the description of the invention has included description of one or more embodiments and certain variations and modifications, other variations and modifications are within the scope of the invention, e.g. as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation. Rather, as the flowing claims reflect, inventive aspects lie in less than all features of any single foregoing disclosed embodiment.

What is claimed is:

1. A surface piercing tidal generator comprising:
a floating structure that floats on a moving body of water;
an elongated member coupled to the floating structure and substantially parallel to a surface of the water; and
a plurality of high aspect ratio rotor blades that extend radially from the elongated member with portions of at least some of the blades extending under the surface of the water; wherein the movement of the water under the surface piercing tidal generator and across a the plurality of rotor blades and the elongated member to rotate.

2. The surface piercing tidal generator of claim 1 further comprising:
an electrical generator that is coupled to the elongated member.

3. The surface piercing tidal generator of claim 1 further comprising:
a pump that is coupled to the elongated member.

4. The surface piercing tidal generator of claim 1 further comprising:
a mooring line that is coupled to the floating structure to hold the surface piercing tidal generator stationary.

5. The surface piercing tidal generator of claim 1 wherein the elongated member is substantially aligned with a direction of the moving body of water.

6. The surface piercing tidal generator of claim 1 wherein the elongated member is angled between 15° to 45° relative to a direction of the moving body of water.

7. The surface piercing tidal generator of claim 1 wherein the floating structure includes a fin mounted to a lower surface that is in the moving body of water.

8. A surface piercing tidal generator comprising:
a floating structure that floats on a moving body of water;
a plurality of shafts coupled to the floating structure and positioned above the water and substantially parallel to an upper surface of the water; and
a plurality of rotors that are each mounted on one of the shafts, each of the rotors includes a plurality of pitched high aspect ratio blades that are mounted around the rotor and extend in a radial manner from the center of the rotor and portions of some of the blades are under the surface of the water;
wherein the movement of the water causes the plurality of rotors and the shafts to rotate.

9. The surface piercing tidal generator of claim 1 further comprising:
an electrical generator that is coupled to the shafts.

10. The surface piercing tidal generator of claim 1 further comprising:
a pump that is coupled to the shafts.

11. The surface piercing tidal generator of claim 1 further comprising:
a mooring line that is coupled to the floating structure to hold the structure stationary.

12. The surface piercing tidal generator of claim 1 wherein the shafts are substantially aligned with a direction of the moving body of water.

13. The surface piercing tidal generator of claim 1 wherein the shafts are angled between 15° to 45° relative to a direction of the moving body of water.

14. The surface piercing tidal generator of claim 1 wherein the floating structure includes a fin mounted to a lower surface that is in the moving body of water.

15. A surface piercing tidal generator comprising:
a floating structure that includes two or more pontoons that float on a moving body of water;
a shaft coupled to the floating structure and positioned between the pontoons above the water and substantially parallel to an upper surface of the water; and
a plurality of rotors that are mounted on the shaft, each of the rotors includes a plurality of pitched high aspect ratio blades that are mounted around the rotor and extend in a radial manner from the center of the rotor and portions of some of the blades are under the surface of the water;
wherein the movement of the water causes the plurality of rotors and the shaft to rotate.

16. The surface piercing tidal generator of claim 8 further comprising:
an electrical generator that is coupled to the shaft.

17. The surface piercing tidal generator of claim 8 further comprising:
a pump that is coupled to the shaft.

18. The surface piercing tidal generator of claim 8 further comprising:
a mooring line that is coupled to the floating structure to hold the structure stationary.

19. The surface piercing tidal generator of claim 8 wherein the shaft is substantially aligned with a direction of the moving body of water.

20. The surface piercing tidal generator of claim 8 wherein the shaft is angled between 15° to 45° relative to a direction of the moving body of water.
